(19) United States
(12) Patent Application Publication
(10) Pub. No.: US 2022/0300808 A1
(43) Pub. Date: Sep. 22, 2022

(54) METHOD FOR ENGINE PERFORMANCE DEGRADATION PREDICTION BASED ON THE EC-RBELM ALGORITHM

(71) Applicant: NANJING UNIVERSITY OF AERONAUTICS AND ASTRONAUTICS, Jiangsu (CN)

(72) Inventors: Feng LU, Jiangsu (CN); Shuai ZHAO, Jiangsu (CN); Jinquan HUANG, Jiangsu (CN); Jianbing CAI, Jiangsu (CN); Zhaoguang WANG, Jiangsu (CN); Shugang ZHANG, Jiangsu (CN)

(73) Assignee: NANJING UNIVERSITY OF AERONAUTICS AND ASTRONAUTICS, Jiangsu (CN)

(21) Appl. No.: 17/610,159

(22) PCT Filed: May 13, 2021
(86) PCT No.: PCT/CN2021/093703

§ 371 Date: Nov. 10, 2021

(30) Foreign Application Priority Data
Sep. 30, 2020 (CN) 202011058846.2

(51) Int. Cl. G06N 3/08; G06N 3/04

(52) U.S. Cl. CPC G06N 3/08; G06N 3/0445; G06N 3/0454

(57) ABSTRACT

A method for engine performance degradation prediction based on the EC-RBELM algorithm, including establishing a prediction model cluster for three performance parameters, i.e., gas turbine speed Ng, power turbine inlet temperature T45 and specific fuel consumption SFC, in different atmospheric environments based on the EC-RBELM algorithm; learning EC-RBELM network topology parameters offline and automatically updating EC-RBELM network topology parameters based on prediction errors; and predicting the degradation of individual performance parameters of the turboshaft engine in different atmospheric environments according to the EC-RBELM algorithm model.

### TECHNICAL FIELD

The present invention relates to the field of aero-engine performance parameter prediction, and in particular, relates to a method for engine performance degradation prediction based on the Error Control Restricted Boltzmann Extreme Learning Machine (EC-RBELM) algorithm.

### DESCRIPTION OF RELATED ART

With small size and complicated structure, turboshaft engines work in harsh environments such as high temperature and high pressure for a long time. Many important rotating components of turboshaft engines, such as compressors, gas turbines and power turbines, are high-speed rotating components. With the increase in the number of flight cycles, the performance parameters of various engine components will degrade to different degrees, inevitably leading to a decline in the engine performance, so it is necessary to predict and assess the degradation of engine performance, so as to provide important basis for engine fault diagnosis and maintenance, improve the engine working reliability, and reduce the maintenance cost. Currently, there are three methods of aero-engine gas path analysis: model-based method, data-driven method and knowledge-based method. Among them, the model-based and data-driven methods have been widely studied. The model-based method is mainly based on the establishment of an accurate engine model, but it relies too much on the accuracy of the engine mathematical model. In practice, it is often hard to establish an accurate linear state variable model of engines. Accurate engine performance trend prediction is an important basis for judging engine failure. Using the accurate performance trend prediction results to update the reference performance in the performance calculation algorithm can improve the accuracy of prediction and reduce the occurrence of false alarms.

The greatest advantage of data-based prediction is that it does not rely much on accurate mathematical or physical models of the engine. Neural network is the most typical example. As engine performance degradation is a long-term cumulative process, and its performance degradation process forms a time series, the performance degradation condition can be seen as a time series prediction method. The prediction includes single-step prediction and multi-step prediction. For the multi-step prediction, the results will be less reliable as the number of prediction steps increase, because multi-step prediction generally involves the implementation of single-step prediction for many times, and the error and uncertainty of each single-step prediction will accumulate to the next step. With the development of artificial intelligence in the past 20 years, the data-based neural network algorithm provides a new solution to the nonlinear and complex parameter prediction problem. Liu et al. used the ARMA algorithm to predict the engine speed and achieved good results. Kiakojoori and Vatani et al. used the dynamic neural network to predict the turbine temperature of engine.

Extreme Learning Machine (ELM) is developed on the basis of Single Hidden-layer Feed-forward Networks (SLFNs). Compared with the traditional neural network learning algorithm, ELM has the advantages of fast learning, strong ability of generalization, simple network structure and so on, and has been more widely used in prediction, diagnosis, classification, and regression. The ELM algorithm mainly generates the input weight and bias randomly, and figures out the output weight through the least square method. Also, the ELM algorithm has some disadvantages. As the input layer parameters of the ELM are randomly generated, the results obtained in each test are quite different, resulting in poor stability of the ELM algorithm. To remedy the defect, Restricted Boltzmann Machine (RBM) is used to initialize the input layer parameters of the ELM algorithm, which can reduce the defect of poor stability of the algorithm caused by random initialization of network parameters to a certain extent. However, for the data under other atmospheric conditions of the engine, the generalization of the algorithm is poor and the prediction effect is not good.

### SUMMARY

The present invention proposes a method for engine performance degradation prediction based on the EC-RBELM algorithm to solve the above technical problem. For the degradation of individual engines in different atmospheric conditions at the engine inlet, use different network prediction models according to the temperature, and use offline trained prediction models according to the atmospheric conditions at the engine inlet to carry out a prediction in combination with the MVW and update network topology parameters automatically based on the prediction errors, so as to meet the generalization of the prediction model for the data at the next moment. It is applicable to individual differences in the prediction of different engine performance parameters. The simulation results indicate that the method for engine performance degradation prediction based on the EC-RBELM algorithm is feasible and effective.

To solve the technical problem above, the present invention employs the following technical solution.

A method for engine performance degradation prediction based on the EC-RBELM algorithm, comprising the following steps.

Step 1), establishing a prediction model cluster for three performance parameters, i.e., gas turbine speed Ng, power turbine inlet temperature T45 and specific fuel consumption SFC, in different atmospheric environments based on the EC-RBELM algorithm.

Step 2), learning EC-RBELM network topology parameters offline and automatically updating EC-RBELM network topology parameters based on prediction errors.

Step 3), predicting the degradation of individual performance parameters of the turboshaft engine in different atmospheric environments according to the EC-RBELM algorithm model.

Specifically, the said Step 1), i.e., establishing a prediction model cluster for three performance parameters, i.e., gas turbine speed Ng, power turbine inlet temperature T45 and specific fuel consumption SFC, in different atmospheric environments based on the EC-RBELM algorithm, comprises the following steps.

Step 1.1), normalizing the turboshaft engine degradation parameters, including the gas turbine speed Ng, fuel flow Wf, sensor measurement parameters of each section such as Wa2, P3, T3, T45, T5, and specific fuel consumption SFC.

Step 1.2), classifying the atmospheric environments by the temperature at the engine inlet at a certain atmospheric pressure.

Step 1.3), establishing performance parameter degradation prediction models of the EC-RBELM separately for different atmospheric environments, specifically expressed as follows:

Ng prediction model:

Ng(t+n)ₑ=f(Wa2(t)ₑ, P3(t)ₑ, T3(t)ₑ, Wf(t)ₑ, T5(t)ₑ)

T45 prediction model:

T45(t+n)ₑ=f(Wa2(t)ₑ, P3(t)ₑ, T3(t)ₑ, Wf(t)ₑ, T5(t)ₑ)

SFC prediction model:

SFC (t+n)ₑ=f(Wa2(t)ₑ, P3(t)ₑ, T3(t)ₑ, Wf(t)ₑ, T5(t)ₑ)

Wherein, n refers to the prediction step; e refers to the atmospheric environment; and t refers to the current time.

Specifically, the said Step 2), i.e., learning EC-RBELM network topology parameters offline and automatically updating EC-RBELM network topology parameters based on prediction errors, comprises the following steps.

Step 2.1), it is known that [symbol] ={(xᵢ,tᵢ)|xᵢ∈Rⁿ,tᵢ∈R^{m},i=1,2, . . . , N}, wherein i refers to the number of samples, n refers to the dimension of input data, m refers to the dimension of output data, g(x) refers to the activation function of hidden layer, L refers to the number of hidden nodes, and η refers to the learning rate.

Step 2.2), generating the input weight w and the hidden layer bias b randomly, and updating the input weight w and the hidden layer bias b according to the contrastive divergence algorithm. The calculation is as follows:

wₐⱼ=ηg( [symbol] vₐghⱼ [symbol] _{data}− [symbol] vₐghⱼ [symbol] _{rec})

bⱼ=ηg( [symbol] hⱼ [symbol] _{data}− [symbol] hⱼ [symbol] _{rec})

Wherein, η refers to the learning rate; the subscript data refers to the initial value of the training sample; the subscript rec refers to the reconstructed value calculated according to the contrastive divergence algorithm; v and h refer to the neuron of the input layer and hidden layer respectively; a and j refer to the No. a neuron of the input layer and the No. j neuron of the hidden layer respectively.

Step 2.3), calculating the output matrix H and output weight β of the hidden layer:

$$H ( {w}_{i} , K , {w}_{L} , {b}_{i} , K {b}_{L} ) = {[ \begin{matrix}g ( {w}_{1}^{T} {x}_{1} + {b}_{1} ) & K & g ( {w}_{L}^{T} {x}_{1} + {b}_{L} ) \\ M & K & M \\ g ( {w}_{1}^{T} {x}_{N} + {b}_{1} ) & K & g ( {w}_{L}^{T} {x}_{N} + {b}_{L} )\end{matrix} ]}_{N \times L} \\ β = {H}^{+} T$$

Wherein, w=[w₁, w₂, . . . , w_{L}]^{T} is the input weight; b=[b₁,b₂, . . . ,b_{L}]^{T} is the network hidden layer bias, and T=[t₁, t₂, . . . , t_{N}]^{T} expected output matrix.

Step 2.4), calculating the weight coefficient based on the Minimum Variance Weight (MVW),

Step 2.5), determining the prediction time step, setting the threshold e and the maximum number of iterations max, and calculating the predicted weighted value of Step k. Training the network topology parameters again if the predicted and expected values exceed the set thresholds;

Step 2.6), setting k=k+1, and returning to Step 2.2).

Specifically, the said Step 2.4), i.e., calculating the weight coefficient based on the MVW, comprises the following steps.

Step 2.4.1), for the p trained EC-RBELM networks, the combined predicted value in Step k is expressed as follows:

dₖ=α₁d¹(k)+α₂d²(k)+L+αₚd^{p}(k)

s.t.α₁+α₂+Lαₚ=1

Wherein, d^{r}(k),r=1,2,L p the predicted value of the EC-RBELM network in Step k; αᵣ=[α₁,α₂,L,αₚ] is the weight coefficient of p EC-RBELM networks.

Step 2.4.2), defining the variance of the prediction error as follows:

var(eₖ)=α₁²var(eₖ¹)+α₂²var(eₖ²)+L+αₚ²var(eₖ^{p})=α₁α₂cov(eₖ¹, eₖ²)+L+αₚ₋₁αₚcov(eₖ^{p-1}, eₖ^{p})

Wherein, e^{r}(k), r=1, 2, L p is the prediction error of the EC-RBELM network in Step k.

Step 2.4.3), as the prediction results of p models are independent of each other, the covariance is equal to zero, and the objective function is simplified as follows:

$$var ( {e}_{k} ) = {\sum }_{i = 1}^{p} {α}_{i}^{2} {σ}_{ii}$$

Wherein, σᵢᵢ is the variance of the prediction error.

Step 2.4.4), using the Lagrange multiplier to figure out the minimum of var(eₖ) and obtaining the weight coefficient as follows:

$${α}_{i} = \frac{1}{{σ}_{ii} ( 1 / {σ}_{11} + 1 / {σ}_{22} + L + 1 / {σ}_{pp} )}$$

Specifically, the said Step 2.5), i.e., determining the prediction time step, setting the threshold e and the maximum number of iterations max, calculating the predicted weighted value of Step k and re-training the network topology parameters if the predicted and expected values exceed the set thresholds, comprises the following steps.

Step 2.5.1), taking a value every 25 hours. As it is needed to predict the performance parameters Ng, T45 and SFC of the engine 50 hours in advance, the prediction time step is n=2.

Step 2.5.2), calculating the weight prediction output of the EC-RBELM network in Step k as follows:

\hat{d}^{k}=[d¹(k), d²(k), L, d^{p}(k)]gα

Wherein, α=[α₁, α₂, L, αₚ]^{T} is the integrated weight coefficient.

Step 2.5.3), defining the error e(k) of Step k, and calculating it as follows:

e₁(k)=|d_{Ng}^{k}−\hat{d}_{Ng}^{k}|

e₂(k)=|d_{T}_{₄₅}^{k}−\hat{d}_{T}_{₄₅}^{k}|

e₃(k)=|d_{SFC}^{k}−\hat{d}_{SFC}^{k}|

Wherein, d^{k} is the actual value in Step k, and d^{k} is the predicted value in Step k.

Step 2.5.4), determining whether the current error e(k) is less than the threshold e. If it exceeds the set threshold, the network topology parameters will be retrained until it is within the set error threshold or the maximum number of iterations.

Specifically, the said Step 3), predicting the degradation of individual performance parameters of the turboshaft engine in different atmospheric environments based on the EC-RBELM algorithm, comprises the following steps.

Step 3.1), normalizing the engine data for testing, including the gas turbine speed Ng, fuel flow Wf, sensor measurement parameters of each section such as Wa1, P3, T3, T45, T5, and specific fuel consumption SFC.

Step 3.2), using adjacent network prediction models under the atmospheric conditions to carry out a prediction respectively according to the atmospheric conditions at the inlet of the tested engine and the temperature, and obtaining the predicted values under the atmospheric conditions by weighted summation.

Specifically, the said Step 3.2), i.e., using adjacent network prediction models under the atmospheric conditions to carry out a prediction respectively according to the atmospheric conditions at the inlet of the tested engine and the temperature, and obtaining the predicted values under the atmospheric conditions by weighted summation, comprises the following steps.

Step 3.2.1), using the adjacent network models and calculating the weight coefficient α of the predicted values according to the inlet temperature of the tested engine.

Step 3.2.2), obtaining the predicted values under the atmospheric conditions and temperature at the engine inlet by weighted summation:

\hat{d}=α₁g\hat{d}₁+α₂g\hat{d}₂

Wherein, \hat{d} is the predicted value of the test point; \hat{d}₁, \hat{d}₂ are the predicted value of the adjacent network prediction models respectively.

Benefits: 1. The method for engine performance degradation prediction based on the EC-RBELM algorithm proposed in the present invention solves the problem of poor generalization of the data-based method under different atmospheric conditions at the inlet in the process of engine degradation.

2. The MVW-based method designed in the present invention can calculate the weight coefficient of each network model according to the predicted value, which makes up the disadvantage that each single prediction model has the same contribution to the prediction result in the weighted mean method.

3. The EC-RBELM-based algorithm designed in the present invention can update the topology parameters of the network online according to the set threshold, so as to meet the generalization of the prediction model for the data at the next moment. The network has certain self-tuning ability. It is applicable to individual differences in the prediction of different engine performance parameters, and plays a positive role in promoting health management and maintenance cost reduction of the turboshaft engine.

### BRIEF DESCRIPTION OF THE DRAWINGS

FIG. 1 is a schematic diagram of the method for engine performance degradation prediction under different atmospheric conditions proposed in the present invention.

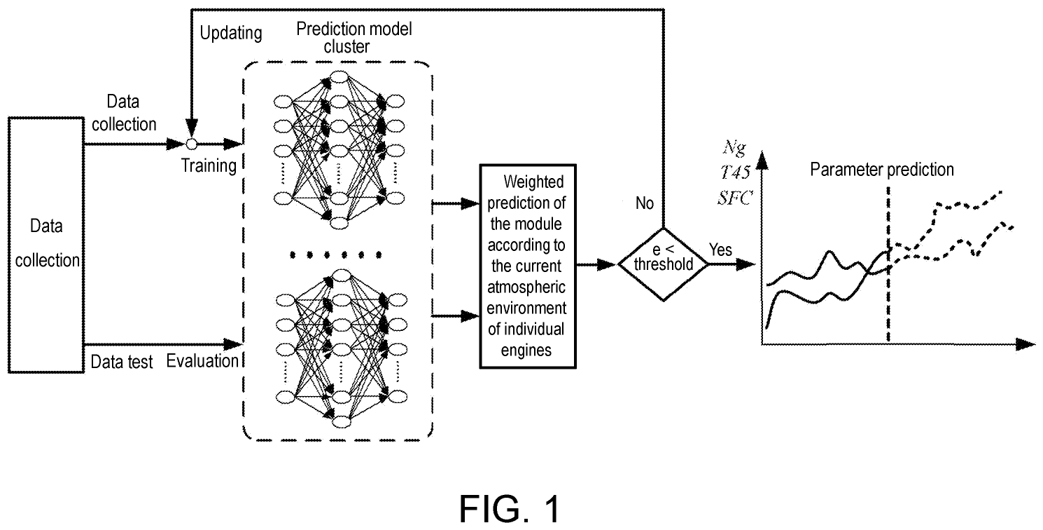

FIG. 2 is a schematic diagram of the weighted prediction model of EC-RBELM.

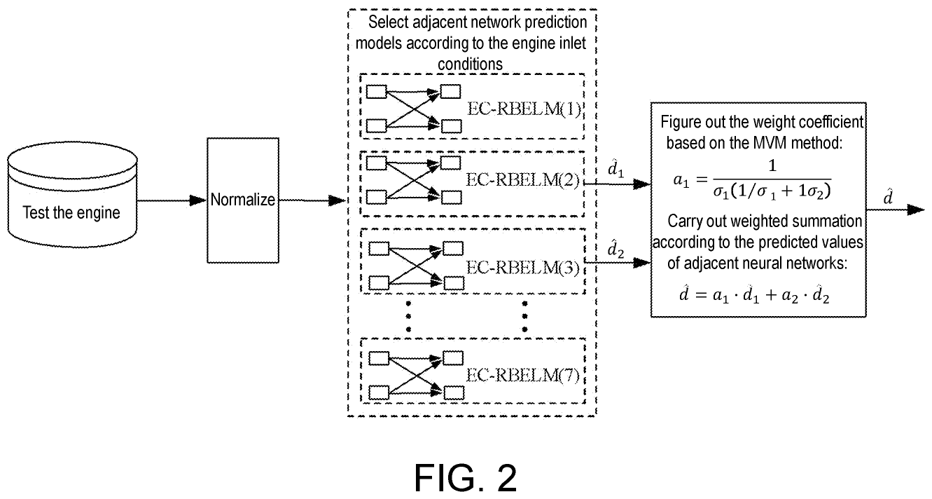

FIG. 3 is a sectional view of the turboshaft engine gas path.

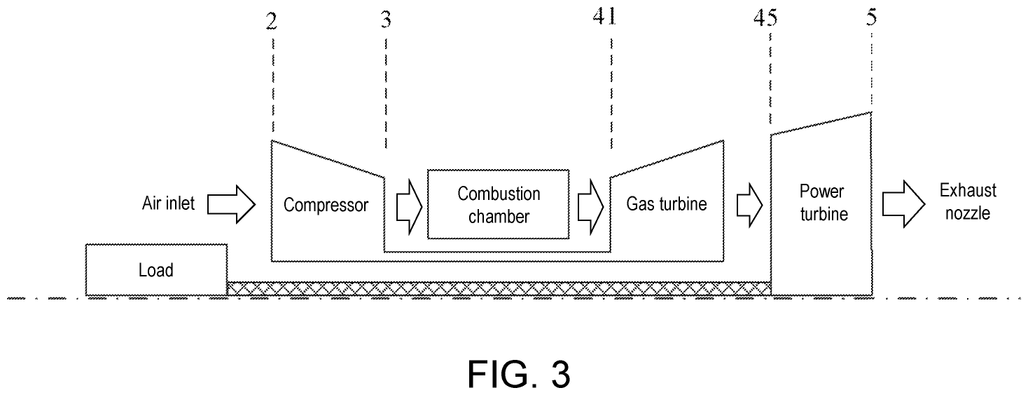

FIG. 4 shows the prediction result of three performance parameters of Engine #8 in a standard environment (p=1 atm, t=15° C.).

FIG. 5 shows the prediction result of three performance parameters of Engine #8 in the environment \textcircled{1} (p=0.98 atm, t=−25° C.).

FIG. 6 shows the prediction result of three performance parameters of Engine #8 in the environment \textcircled{2} (p=0.98 atm, t=−12° C.).

FIG. 7 shows the prediction result of three performance parameters of Engine #8 in the environment \textcircled{3} (p=0.99atm, t=23° C.).

FIG. 8 shows the prediction result of three performance parameters of Engine #8 in the environment \textcircled{4} (p=0.99 atm, t=35° C.).

### DESCRIPTION OF THE EMBODIMENTS

The embodiment of the present invention is further explained as follows in combination with the attached drawings.

The present invention describes a method for engine performance degradation prediction based on the EC-RBELM algorithm, including the following steps specifically:

Step 1), establishing a prediction model cluster for three performance parameters, i.e., gas turbine speed Ng, power turbine inlet temperature T45 and specific fuel consumption SFC, in different atmospheric environments based on the EC-RBELM algorithm.

Step 1.1), normalizing the turboshaft engine degradation parameters, including the gas turbine speed Ng, fuel flow Wf, sensor measurement parameters of each section such as Wa2, P3, T3, T45, T5, and specific fuel consumption SFC.

Step 1.2), classifying the atmospheric environments by the temperature at the engine inlet at a certain atmospheric pressure.

Step 1.3), establishing performance parameter degradation prediction models of the EC-RBELM separately for different atmospheric environments, specifically expressed as follows:

Ng prediction model:

Ng(t+n)ₑ=f(Wa2(t)ₑ, P3(t)ₑ, T3(t)ₑ, Wf(t)ₑ, T5(t)ₑ)

T45 prediction model:

T45(t+n)ₑ=f(Wa2(t)ₑ, P3(t)ₑ, T3(t)ₑ, Wf(t)ₑ, T5(t)ₑ)

SFC prediction model:

SFC(t+n)ₑ=f(Wa2(t)ₑ, P3(t)ₑ, T3(t)ₑ, Wf(t)ₑ, T5(t)ₑ)

Wherein, n refers to the prediction step; e refers to the atmospheric environment; and t refers to the current time.

Step 2), learning EC-RBELM network topology parameters offline and automatically updating EC-RBELM network topology parameters based on prediction errors.

Step 2.1), it is known that [symbol] ={xᵢ, tᵢ)|xᵢ∈Rⁿ, tᵢ∈R^{m}, i=1, 2, . . . , N}, wherein i refers to the number of samples, n refers to the dimension of input data, m refers to the dimension of output data, g(x) refers to the activation function of hidden layer, L refers to the number of hidden nodes, and η refers to the learning rate.

Step 2.2), generating the input weight w and the hidden layer bias b randomly, and updating the input weight w and the hidden layer bias b according to the contrastive divergence algorithm. The calculation is as follows:

wₐⱼ=ηg( [symbol] vₐghⱼ [symbol] _{data}− [symbol] vₐghⱼ [symbol] _{rec})

bⱼ=ηg( [symbol] hⱼ [symbol] _{data}− [symbol] hⱼ [symbol] _{rec})

Wherein, η refers to the learning rate; the subscript data refers to the initial value of the training sample; the subscript rec refers to the reconstructed value calculated according to the contrastive divergence algorithm; v and h refer to the neuron of the input layer and hidden layer respectively; a and j refer to the No. a neuron of the input layer and the No. j neuron of the hidden layer respectively.

Step 2.3), calculating the output matrix H and output weight β of the hidden layer:

$$H ( {w}_{i} , K , {w}_{L} , {b}_{i} , K {b}_{L} ) = {[ \begin{matrix}g ( {w}_{1}^{T} {x}_{1} + {b}_{1} ) & K & g ( {w}_{L}^{T} {x}_{1} + {b}_{L} ) \\ M & K & M \\ g ( {w}_{1}^{T} {x}_{N} + {b}_{1} ) & K & g ( {w}_{L}^{T} {x}_{N} + {b}_{L} )\end{matrix} ]}_{N \times L} \\ β = {H}^{+} T$$

Wherein, w=[w₁, w₂, . . . , w_{L}]^{T} is the input weight; b=[b₁, b₂, . . . , b_{L}]^{T} is the bias parameter of the network hidden layer, and T=[t₁, t₂, . . . , t_{N}]^{T} is the expected output matrix.

Step 2.4), calculating the weight coefficient based on the Minimum Variance Weight (MVW).

Step 2.4.1), for the p trained EC-RBELM networks, the combined predicted value in Step k is expressed as follows:

dₖ=α₁d¹(k)+α₂d²(k)+L+αₚd^{p}(k)

s.t.α₁+α₂+Lαₚ=1

Wherein, d^{r}(k), r=1, 2, L p is the predicted value of the EC-RBELM network in Step k; αᵣ=[α₁, α₂, L, αₚ] is the weight coefficient of p EC-RBELM networks.

Step 2.4.2), defining the variance of the prediction error as follows:

var(eₖ)=α₁²var(eₖ¹)+α₂²var(eₖ²)+L+αₚ²var(eₖ^{p})=α₁α₂cov(eₖ¹, eₖ²)+L+αₚ₋₁αₚcov(eₖ^{p-1}, eₖ^{p})

Wherein, e^{r}(k), r=1, 2, L p is the prediction error of the EC-RBELM network in Step k.

Step 2.4.3), as the prediction results of p models are independent of each other, the covariance is equal to zero, and the objective function is simplified as follows:

$$var ( {e}_{k} ) = {\sum }_{i = 1}^{p} {α}_{i}^{2} {σ}_{ii}$$

Wherein, σᵢᵢ is the variance of the prediction error.

Step 2.4.4), using the Lagrange multiplier to figure out the minimum of var(eₖ), and obtaining the weight coefficient as follows:

$${α}_{i} = \frac{1}{{σ}_{ii} ( 1 / {σ}_{11} + 1 / {σ}_{22} + L + 1 / {σ}_{pp} )}$$

Step 2.5), determining the prediction time step, setting the threshold e and the maximum number of iterations max, and calculating the predicted weighted value of Step k. Training the network topology parameters again if the predicted and expected values exceed the set thresholds.

Step 2.5.1), taking a value every 25 hours. As it is needed to predict the performance parameters Ng, T45 and SFC of the engine 50 hours in advance, the prediction time step is n=2.

Step 2.5.2), calculating the weight prediction output of the EC-RBELM network in Step k as follows:

\hat{d}^{k}=[d¹(k), d²(k), L, d^{p}(k)]gα

Wherein, α=[α₁, α₂, L, αₚ]^{T} is the integrated weight coefficient.

Step 2.5.3), defining the error e(k) of Step k, and calculating it as follows:

e₁(k)=|d_{Ng}^{k}−\hat{d}_{Ng}^{k}|

e₂(k)=|d_{T}_{₄₅}^{k}−\hat{d}_{T}_{₄₅}^{k}|

e₃(k)=|d_{SFC}^{k}−\hat{d}_{SFC}^{k}|

Wherein, d^{k} is the actual value in Step k, and \hat{d}^{k} is the predicted value in Step k.

Step 2.5.4), determining whether the current error e(k) is less than the threshold e. If it exceeds the set threshold, the network topology parameters will be retrained until it is within the set error threshold or the maximum number of iterations.

Step 2.6), setting k=k+1, and returning to Step 2.2).

Step 3), predicting the degradation of individual performance parameters of the turboshaft engine in different atmospheric environments according to the EC-RBELM algorithm model.

Step 3.1), normalizing the engine data for testing, including the gas turbine speed Ng, fuel flow Wf, sensor measurement parameters of each section such as Wa2, P3, T3, T45, T5, and specific fuel consumption SFC.

Step 3.2), using adjacent network prediction models under the atmospheric conditions to carry out a prediction respectively according to the atmospheric conditions at the inlet of the tested engine and the temperature, and obtaining the predicted values under the atmospheric conditions by weighted summation.

Step 3.2.1), using the adjacent network models and calculating the weight coefficient α of the predicted values according to the inlet temperature of the tested engine.

Step 3.2.2), obtaining the predicted values under the atmospheric conditions and temperature at the engine inlet by weighted summation:

\hat{d}=α₁g\hat{d}₁+α₂g\hat{d}₂

Wherein, \hat{d} is the predicted value of the test point; \hat{d}₁, \hat{d}₂ are the predicted value of the adjacent network prediction models respectively.

The present invention simulates the degradation process of the turboshaft engine under the condition of constant power turbine speed and constant power. Health parameter degradation is used to simulate the real degradation of the engine, without considering the repair condition during the engine operation. Therefore, each health parameter of the rotor component changes monotonically. Corresponding networks are trained under the condition of p=1 atm and inlet temperature t=−30° C., t=−20° C., t=−10° C., t=0° C., t=15° C., t=30° C. and t=40° C. separately, thus the network prediction models of 7 engines are trained in total. The present invention takes 5 different atmospheric environments at the inlet of the Engine #8 as the test data to verify the effectiveness of the EC-RBELM algorithm. The 5 atmospheric environments are respectively the standard environment (p=1 atm, t=15° C.), environment \textcircled{1} (p=0.98 atm, t=−25° C.), environment \textcircled{2} (p=0.98 atm, t=−12° C.), environment \textcircled{3} (p=0.99 atm, t=23° C.) and environment \textcircled{4} (p=0.99atm, t=35° C.).

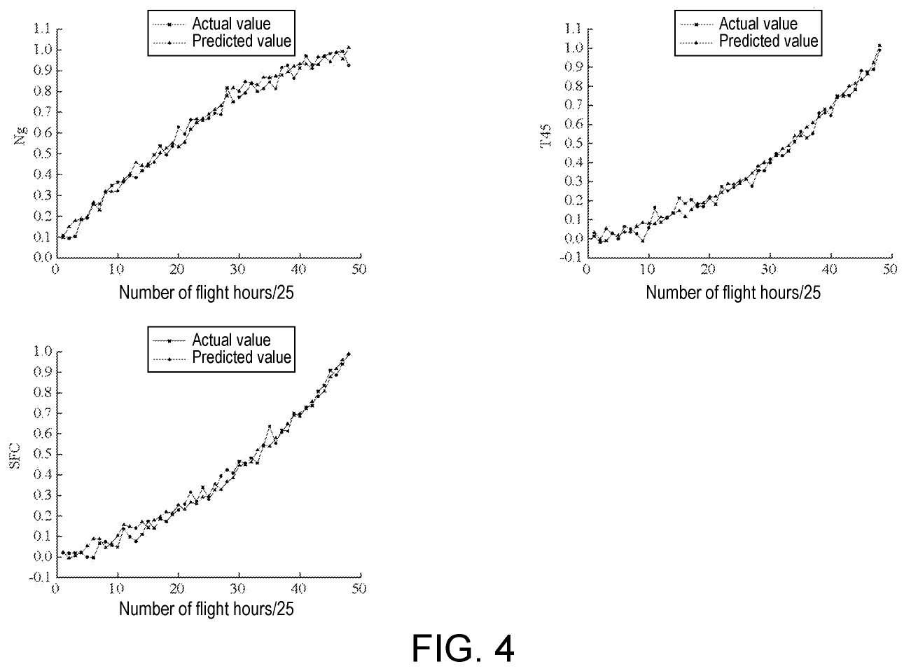

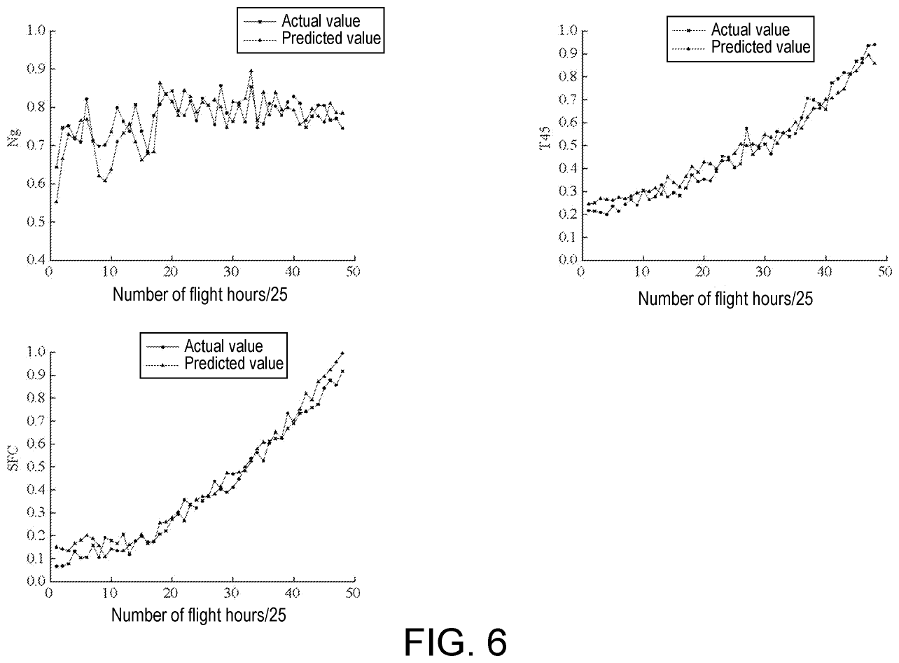

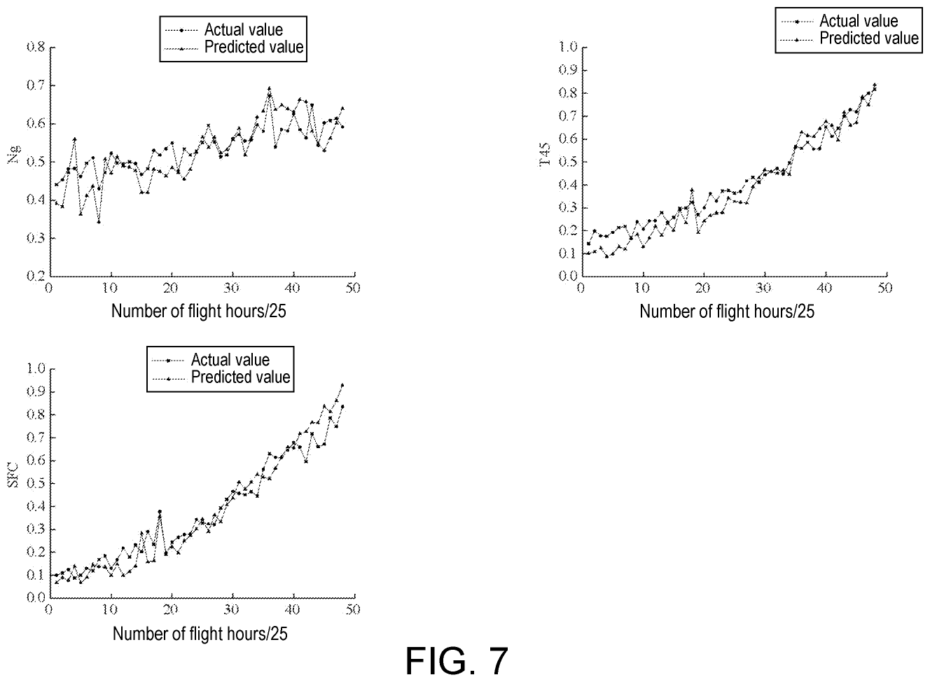

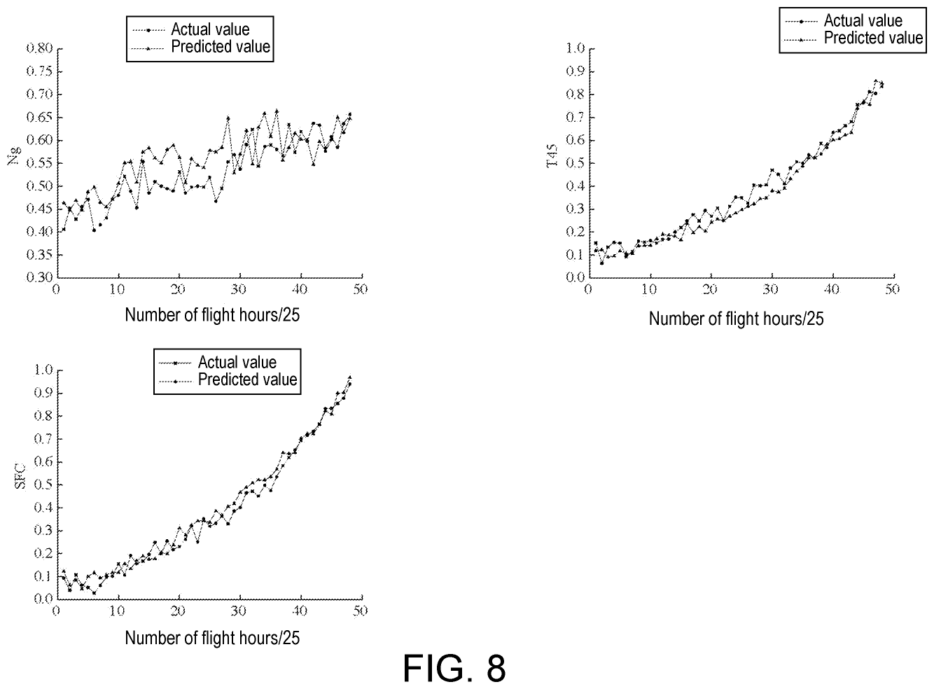

Engine models are used to simulate the engine degradation of the turboshaft engine in 1,250 hours, and the variation range of data in each adjacent time interval is quite small. Take a value every 25 hours. There are 50 sets of values. As it is needed to predict the parameters of the engine 50 hours in advance, the prediction time step is n=2. In the EC-RBELM algorithm, the number of hidden layers is set to 11, the momentum is 0.5, the learning rate is 0.01, the activation function of hidden layers is Gaussian function, the maximum number of iterations is 100, and the failure threshold is 0.1. All sensor data is added with the Gaussian noise 0.03 to simulate the real engine operation, and the prediction results are normalized in a range from 0 to 1. For the convenience of comparison, the performance index is defined as follows:

$$RMSE = \sqrt{\frac{1}{N} {\sum }_{i = 1}^{N} {( {d}_{i} - {\hat{d}}_{i} )}^{2}} \\ MAE = \frac{{\sum }_{i = 1}^{N} \vert {d}_{i} - {\hat{d}}_{i} \vert}{N}$$

Wherein, RMSE, MAE are respectively the root mean square error and the mean absolute error of prediction, both of which can reflect the prediction accuracy and stability of the algorithm. The following FIG. 4-8 and Table 1-5 show the prediction results in 5 test environments.

TABLE 1
Comparison of Prediction Results for Engine #8 in a Standard
Environment (p = 1 atm, t = 15° C.)

| Performance Index | Ng | T45 | SFC |
|---|---|---|---|
| RMSE | 0.0555 | 0.0381 | 0.0377 |
| MAE | 0.0457 | 0.0313 | 0.0303 |

TABLE 2
Comparison of Prediction Results for Engine #8 in Environment \textcircled{1}
(p = 0.98 atm, t = −25° C.)

| Performance Index | Ng | T45 | SFC |
|---|---|---|---|
| RMSE | 0.0562 | 0.0398 | 0.0423 |
| MAE | 0.0500 | 0.0322 | 0.0342 |

TABLE 3
Comparison of Prediction Results for Engine #8 in Environment \textcircled{2}
(p = 0.98 atm, t = −12° C.)

| Performance Index | Ng | T45 | SFC |
|---|---|---|---|
| RMSE | 0.0514 | 0.0439 | 0.0522 |
| MAE | 0.0421 | 0.0497 | 0.0422 |

TABLE 4
Comparison of Prediction Results for Engine #8 in Environment \textcircled{3}
(p = 0.99 atm, t = 23° C.)

| Performance Index | Ng | T45 | SFC |
|---|---|---|---|
| RMSE | 0.0634 | 0.0583 | 0.0417 |
| MAE | 0.0512 | 0.0503 | 0.0336 |

TABLE 5
Comparison of Prediction Results for Engine #8 in Environment \textcircled{4}
(p = 0.99 atm, t = 35° C.)

| Performance Index | Ng | T45 | SFC |
|---|---|---|---|
| RMSE | 0.0677 | 0.0437 | 0.0409 |
| MAE | 0.0541 | 0.0367 | 0.0328 |

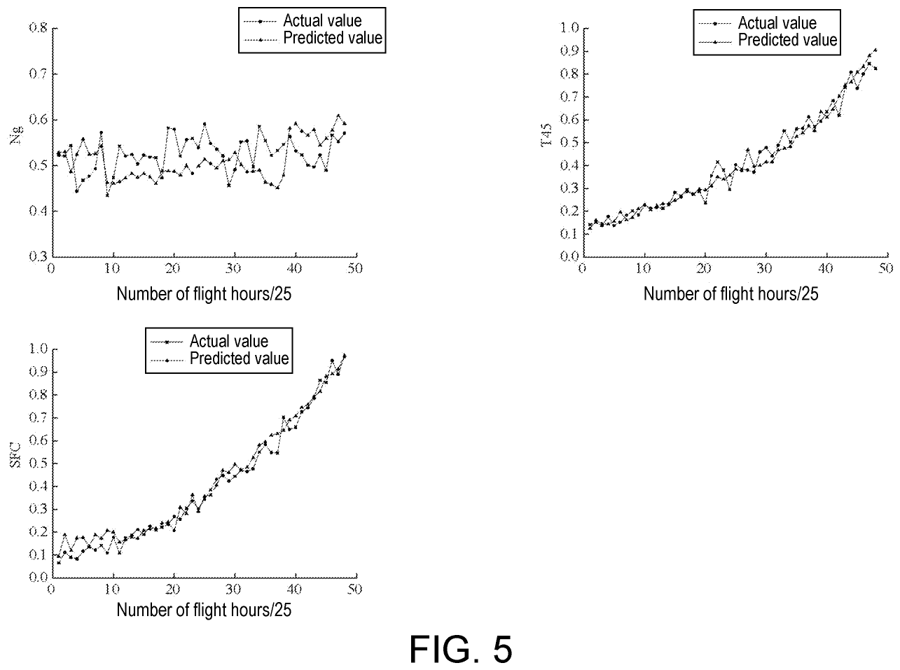

It can be seen from FIG. 5 to FIG. 8 that, under different atmospheric environments, the EC-RBELM algorithm proposed by in the present invention can adjust the network parameters in time according to the error between the current predicted value and the real value to adapt to the difference in the prediction of individual engine performance parameters. The predicted parameters Ng, T45 and SFC within the set threshold match the change trend of the actual parameters well. The curve is basically in the middle of the actual value, which is a good prediction of its change trend. According to Table 1˜5, under different atmospheric environments, the mean of the predicted RMSE of Ng, T45 and SFC are 0.0588, 0.0447 and 0.0429 respectively; the mean of the predicted MAE are 0.0486, 0.0400 and 0.0346 respectively. The prediction errors of the algorithm are all within the set threshold, which reflects the sound generalization and self-tuning ability of the EC-RBELM network model.

It should be noted that the above is only a specific embodiment of the present invention, but the protection cope of the invention is not limited to it. Any changes and substitutions which can be easily thought of by any technical personnel familiar with the technical field within the technical scope disclosed by the present invention should be within the protection scope of the present invention. Therefore, the protection scope of the present invention should be subject to that of the claims.

1. A method for engine performance degradation prediction based on the EC-RBELM algorithm, comprising the following steps:
Step 1), establishing a prediction model cluster for three performance parameters, i.e., gas turbine speed Ng, power turbine inlet temperature T45 and specific fuel consumption SFC, in different atmospheric environments based on the EC-RBELM algorithm;
Step 2), learning EC-RBELM network topology parameters offline and automatically updating EC-RBELM network topology parameters based on prediction errors;
Step 3), predicting the degradation of individual performance parameters of a turboshaft engine in different atmospheric environments according to the EC-RBELM algorithm model.

2. The method for engine performance degradation prediction based on the EC-RBELM algorithm according to claim 1, wherein the Step 1), i.e., establishing the prediction model cluster for three performance parameters, i.e., gas turbine speed Ng, power turbine inlet temperature T45 and specific fuel consumption SFC, in different atmospheric environments based on the EC-RBELM algorithm, specifically comprises the following steps:
Step 1.1), normalizing the turboshaft engine degradation parameters, including the gas turbine speed Ng, fuel flow Wf, sensor measurement parameters of each section such as Wa2, P3, T3, T45, T5, and specific fuel consumption SFC;
Step 1.2), classifying the atmospheric environments by the temperature at the engine inlet at a certain atmospheric pressure;
Step 1.3), establishing performance parameter degradation prediction models of the EC-RBELM separately for different atmospheric environments, specifically expressed as follows:
Ng prediction model:
Ng(t+n)ₑ=f(Wa2(t)ₑ,P3(t)ₑ,T3(t)ₑ, Wf(t)ₑ, T5(t)ₑ)
T45 prediction model:
T45(t+n)ₑ=f(Wa2(t)ₑ, P3(t)ₑ, T3(t)ₑ, Wf(t)ₑ, T5(t)ₑ)
SFC prediction model:
SFC(t+n)ₑ=f(Wa2(t)ₑ, P3(t)ₑ, T3(t)ₑ, Wf(t)ₑ, T5(t)ₑ)
wherein, n refers to the prediction step; e refers to the atmospheric environment; and t refers to the current time.

3. The method for engine performance degradation prediction based on the EC-RBELM algorithm according to claim 1, wherein the Step 2), i.e., learning EC-RBELM network topology parameters offline and automatically updating EC-RBELM network topology parameters based on prediction errors, specifically comprises the following steps:
Step 2.1), it is known that [symbol] ={(xᵢ,tᵢ)|xᵢ∈Rⁿ,tᵢ∈R^{m},i=1,2, . . . ,N}, wherein i refers to the number of samples, n refers to the dimension of input data, m refers to the dimension of output data, g(x) refers to the activation function of hidden layer, L refers to the number of hidden nodes, and η refers to the learning rate;
Step 2.2), generating an input weight w and a hidden layer bias b randomly, and updating the input weight w and the hidden layer bias b according to the contrastive divergence algorithm. The calculation is as follows:
wₐⱼ=ηg( [symbol] vₐghⱼ [symbol] _{data}− [symbol] vₐghⱼ [symbol] _{rec})
bⱼ=ηg( [symbol] hⱼ [symbol] _{data}− [symbol] hⱼ [symbol] _{rec})
wherein, η refers to the learning rate; the subscript data refers to the initial value of the training sample; the subscript rec refers to the reconstructed value calculated according to the contrastive divergence algorithm; v and h refer to the neuron of the input layer and hidden layer respectively; a and j refer to the No. a neuron of the input layer and the No. j neuron of the hidden layer respectively;
Step 2.3) calculating the output matrix H and output weight β of the hidden layer:
$$H ( {w}_{i} , K , {w}_{L} , {b}_{i} , K {b}_{L} ) = {[ \begin{matrix}g ( {w}_{1}^{T} {x}_{1} + {b}_{1} ) & K & g ( {w}_{L}^{T} {x}_{1} + {b}_{L} ) \\ M & K & M \\ g ( {w}_{1}^{T} {x}_{N} + {b}_{1} ) & K & g ( {w}_{L}^{T} {x}_{N} + {b}_{L} )\end{matrix} ]}_{N \times L} \\ β = {H}^{+} T$$
wherein, w=[w₁,w₂, . . . ,w_{L}]^{T} is the input weight; b=[b₁,b₂, . . . ,b_{L}]^{T} is the network hidden layer bias, and T=[t₁,t₂, . . . ,t_{N}]^{T} is the expected output matrix;
Step 2.4), calculating the weight coefficient based on the Minimum Variance Weight (MVW);
Step 2.5), determining the prediction time step, setting the threshold e and the maximum number of iterations max, and calculating the predicted weighted value of step k and then training the network topology parameters again if the predicted and expected values exceed the set thresholds;
Step 2.6), setting k=k+1, and returning to Step 2.2).

4. The method for engine performance degradation prediction based on the EC-RBELM algorithm according to claim 1, wherein the Step 3), i.e., predicting the degradation of individual performance parameters of the turboshaft engine in different atmospheric environments according to the EC-RBELM algorithm model, specifically comprises the following steps:
Step 3.1), normalizing the engine data for testing, including the gas turbine speed Ng, fuel flow Wf, sensor measurement parameters of each section such as Wa2, P3, T3, T45, T5, and specific fuel consumption SFC;
Step 3.2), using adjacent network prediction models under the atmospheric conditions to carry out a prediction respectively according to the atmospheric conditions at the inlet of the tested engine and the temperature, and obtaining the predicted values under the atmospheric conditions by weighted summation.
